(19) United States
(12) Patent Application Publication
(10) Pub. No.: US 2025/0168722 A1
(43) Pub. Date: May 22, 2025

(54) METHOD FOR SECONDARY CELL GROUP (SCG) CONFIGURATION AND TERMINAL DEVICE

(71) Applicant: SPREADTRUM COMMUNICATIONS (SHANGHAI) CO., LTD., Shanghai (CN)

(72) Inventor: Yun DENG, Shanghai (CN)

(21) Appl. No.: 18/833,685

(22) PCT Filed: Jan. 19, 2023
(86) PCT No.: PCT/CN2023/073122

§ 371 Date: Jul. 26, 2024

(30) Foreign Application Priority Data
Jan. 28, 2022 (CN) 202210107331.X

(51) Int. Cl. H04W 36/00; H04W 36/04; H04W 36/36

(52) U.S. Cl. CPC H04W 36/0069; H04W 36/04; H04W 36/36

(57) ABSTRACT

Methods for SCG configuration and a terminal device are provided. Configuration information of multiple candidate SCGs is received from a network side. The configuration information of the multiple candidate SCGs is stored. If the terminal device determines that the first target SCG fulfills a change condition, PSCell change is performed from a source SCG to a first target SCG, where the first target SCG is one of the multiple candidate SCGs. Alternatively, PSCell change is performed from the source SCG to a second target SCG, where the second target SCG is designated by the network side, and the second target SCG is one of the multiple candidate SCGs or is not included in the multiple candidate SCGs. After the terminal device performs PSCell change from the source SCG to the first/second target SCG, the configuration information of the multiple candidate SCGs remains stored in the terminal device.

### CROSS-REFERENCE TO RELATED APPLICATION(S)

This application is a National Stage of International Application No. PCT/CN2023/073122, field Jan. 19, 2023, which claims priority to Chinese Patent Application No. 202210107331.X filed Jan. 28, 2022, the entire disclosure of which are hereby incorporated by reference.

### TECHNICAL FIELD

The disclosure relates to the field of communication, and in particular to methods and apparatuses for secondary cell group (SCG) configuration, a chip, and a module device.

### BACKGROUND

With a dual connectivity (DC) mechanism, a terminal device can simultaneously utilize resources of two nodes (i.e., a master node (MN) and a secondary node (SN)) for data transmission, which not only improves the data throughput rate, but also improves the mobile performance of the terminal device. The MN is associated with a master cell group (MCG), and the MCG includes at least one primary cell (PCell) and optionally other secondary cells (SCells). The SN is associated with a secondary cell group (SCG), and the SCG includes at least one primary secondary cell (PSCell) and optionally other SCells. When the dual-connected terminal device is moving, a process in which the terminal device performs conditional PSCell change (CPC) from a source SN to a target SN (i.e., the terminal device performs change or switch from a source PSCell to a target PSCell) can include the following: the terminal device obtains multiple candidate SCGs from the source MN, determines a target SCG from the multiple candidate SCGs, and performs change or switch from a source SCG to the target SCG.

In general, in the case where parameters of the multiple candidate SCGs are configured through delta signaling mechanism, after the terminal device performs change to the target SCG, other SCGs (i.e., SCGs other than the target SCG in the multiple candidate SCGs) will be unavailable, and the terminal device releases the other SCGs (i.e., SCGs other than the target SCG in the multiple candidate SCGs). When the terminal device performs SN change next time, the terminal device reobtains multiple candidate SCGs and selects a target SCG, thereby completing the SN change.

However, there can be overlapping candidate SCGs among the multiple candidate SCGs obtained when the terminal device performs SN change each time. As a result, certain communication transmission resources will be wasted by obtaining the candidate SCGs in such a manner.

### SUMMARY

In a first aspect, a method for secondary cell group (SCG) configuration is provided in the present disclosure. The method includes the following. Configuration information of multiple candidate SCGs is received from a network side, where each of the multiple candidate SCGs corresponds to a change condition. The configuration information of the multiple candidate SCGs is stored. In the case where the terminal device determines that the first target SCG fulfills a change condition, PSCell change is performed from a source SCG to a first target SCG, where the first target SCG is one of the multiple candidate SCGs. Alternatively, PSCell change is performed from the source SCG to a second target SCG, where the second target SCG is designated by the network side, and the second target SCG is one of the multiple candidate SCGs or is not included in the multiple candidate SCGs. After the terminal device performs PSCell change from the source SCG to the first target SCG or the second target SCG, the configuration information of the multiple candidate SCGs remains stored in the terminal device.

In a second aspect, a method for SCG configuration is provided in the present disclosure. The method includes the following. Configuration information of multiple candidate SCGs is received from a network side, where each of the plurality of candidate SCGs corresponds to a change condition. Configuration information of some or all of the multiple candidate SCGs is configured through delta signaling, configuration information of candidate SCGs configured through delta signaling is based on at least one set of reference configuration parameters, and the at least one set of reference configuration parameters is configured by the network side.

In a third aspect, a terminal device is provided in implementations of the present disclosure. The terminal device includes a memory and a processor. The memory is configured to store a computer program, and the computer program includes program instructions. The processor is configured to invoke the program instructions to perform the method in the first aspect or in any possible implementation thereof.

### BRIEF DESCRIPTION OF THE DRAWINGS

In order to describe more clearly technical solutions of implementations of the present disclosure, the following will give a brief introduction to accompanying drawings used for describing implementations. Apparently, the accompanying drawings described below are some implementations of the present disclosure. Based on these drawings, those of ordinary skill in the art can also obtain other drawings without creative effort.

FIG. 1 is a schematic diagram of a communication system provided in implementations of the present disclosure.

FIG. 2 is a schematic flowchart of conditional handover (CHO) provided in implementations of the present disclosure.

FIG. 3A is a schematic flowchart of a method for secondary cell group (SCG) configuration provided in implementations of the present disclosure.

FIG. 3B is a schematic flowchart of another method for SCG configuration provided in implementations of the present disclosure.

FIG. 4 is a schematic structural diagram of an apparatus for SCG configuration provided in implementations of the present disclosure.

FIG. 5 is a schematic structural diagram of a terminal device provided in implementations of the present disclosure.

FIG. 6 is a schematic structural diagram of a module device provided in implementations of the present disclosure.

### DETAILED DESCRIPTION

Specific implementations of the present disclosure will be described in detail below with reference to the accompanying drawings.

The terms “first”, “second”, and the like used in the specification, the claims, and the accompanying drawings of the present disclosure are used to distinguish different objects rather than describe a particular order. In addition, the terms “include”, “comprise”, and “have” as well as variations thereof are intended to cover a non-exclusive inclusion. For example, a process, method, system, product, or device including a series of steps or units is not limited to the listed steps or units. Instead, it can optionally include other steps or units that are not listed, or can also include other steps or units inherent to the process, method, product, or device.

The term “implementation” referred to in implementations of the present disclosure means that a particular feature, structure, or characteristic described in conjunction with the implementation can be contained in at least one implementation of the present disclosure. The phrase appearing in various places in the specification does not necessarily refer to the same implementation, nor does it refer to an independent or alternative implementation that is mutually exclusive with other implementations. It is explicitly and implicitly understood by those skilled in the art that an implementation described herein can be combined with other implementations.

In implementations of the present disclosure, “at least one (item)” refers to one or more, “a plurality of” or “multiple” refers to two or more, and “at least two (item)” refers to two or more than three (including three). “And/or” describes an association relationship between associated objects, which means that there can be three relationships. For example, A and/or B can mean A alone, B alone, and both A and B exist, where A and B each can be singular or plural. The character “/” herein generally indicates that associated objects are in an “or” relationship. “At least one (item) of the following” as well as similar expressions thereof refers to any combination of these items, including any combination of a singular one (item) or a plural one (item). For example, at least one (item) of a, b, or c can mean: a, b, c, a-b, a-c, b-c, or a-b-c, where a, b, and c each can be one or multiple.

In order to better understand implementations of the present disclosure, the communication system involved in implementations of the present disclosure will be first described below.

Technical solutions of implementation of the present disclosure can be applied to various communication systems, such as a global system of mobile communication (GSM), a code division multiple access (CDMA) system, a wideband code division multiple access (WCDMA) system, a general packet radio service (GPRS), a long term evolution (LTE) system, and an LTE frequency division duplex (FDD) system, an LTE time division duplex (TDD) system, a universal mobile telecommunication system (UMTS), a worldwide interoperability for microwave access (WiMAX) communication system, a fifth generation (5G) system or new radio (NR), other future communication systems, etc.

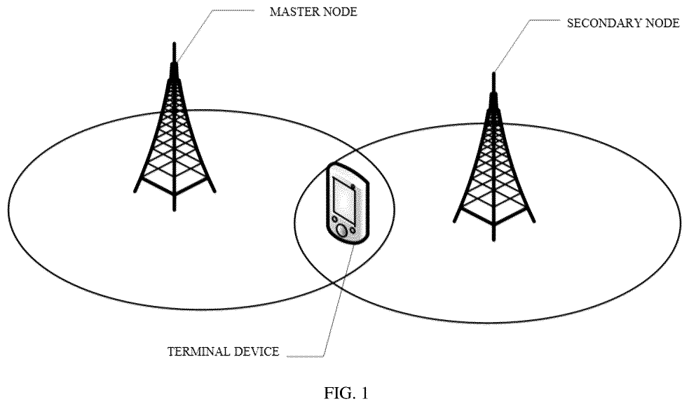

FIG. 1 is a schematic diagram of a communication system provided in implementations of the present disclosure. The communication system is applicable to solutions of the present disclosure. The communication system can include a network device and a terminal device. For illustrative purposes, as illustrated in FIG. 1, the communication system includes two network devices (a master node (MN) and a secondary node (SN)) and one terminal device.

### 1. Terminal Device

A terminal device includes a device that provides voice and/or data connectivity to a user, e.g., a terminal device is a device with wireless transceiver functionality that can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.). The terminal device can be a mobile phone, a vehicle, a roadside unit (RSU), a pad, a computer with wireless transceiver functions, a virtual reality (VR) terminal device, an augmented reality (AR) terminal device, a wireless terminal in industrial control, in-vehicle terminal device, a wireless terminal in self-driving, a wireless terminal in remote medicine, a wireless terminal in smart grid, a wireless terminal in transportation safety, a wireless terminal in smart city, a wireless terminal in smart home, a wearable terminal device, etc. Implementations of the present disclosure do not limit the application scenarios. The terminal device can also be referred to as a terminal, a user equipment (UE), an access terminal device, an in-vehicle terminal, an industrial control terminal, a UE unit, a UE station, a mobile station, a mobile platform, a remote station, a remote terminal device, a mobile device, a UE terminal device, a terminal device, a wireless communication device, a UE agent, a UE apparatus, etc. The terminal can also be fixed or mobile. In implementations of the present disclosure, an apparatus for implementing the functions of the terminal device can be the terminal device or an apparatus capable of supporting the terminal device to implement its functions, such as a chip system or a combined device or component that can implement the functions of the terminal device, which can be installed in the terminal device.

### 2. Network Device

A network device is a node or a device that connects the terminal device to a wireless network. A network side (i.e., network device) involved in the present disclosure includes, but is not limited to, a base station, an evolved NodeB (eNodeB), a transmission reception point (TRP), a next-generation NodeB (gNB) in a 5G mobile communication system, a gNB in a sixth generation (6G) mobile communication system, a base station in a future mobile communication system, an access node in a WiFi system, etc. The base station involved in the present disclosure can also be a module or unit that implements some of the functions of the base station, such as a central unit (CU) or a distributed unit (DU). Herein, the CU implements functions of a radio resource control (RRC) layer and functions of a packet data convergence protocol (PDCP) layer of the base station, and can also implement functions of a service data adaptation protocol (SDAP). The DU implements functions of a radio link control (RLC) layer, functions of a media access control (MAC) layer of the base station, and functions of some or all of physical (PHY) layers. For specific descriptions of the above protocol layers, reference can be made to related technical specifications of the 3rd generation partnership project (3GPP). The base station in the present disclosure can be a macro base station, a micro base station or an indoor station, a relay node, a donor node, etc.

In implementations of the present disclosure, an apparatus for implementing the function of the network side can be the terminal device or an apparatus capable of supporting the network device to implement its function, such as a chip system or a combined device or component that can implement the functions of the network device, which can be installed in the network device. Implementations of the present disclosure do not limit specific technology and specific device forms used by the network device.

In order to facilitate understanding of the technical solutions of the present disclosure, some of the terms involved in the present disclosure are first elaborated below.

### 1. Dual Connectivity (DC)

With a DC technology, a higher data transmission rate can be provided for a terminal device, and spectrum efficiency and load balancing can be improved by utilizing macro/micro networking. As illustrated in FIG. 1, a terminal device supporting DC can simultaneously establish communication connections with two nodes, including an MN and an SN. In a communication system, the terminal device supporting DC is configured with at least two cell groups, where one is a master cell group (MCG) and the other is a secondary cell group (SCG). The MCG refers to a cell group associated with the MN. The MCG includes one primary cell (PCell) and optionally one or more secondary cells (SCells). The PCell in the MCG is a cell that establishes an RRC connection with the terminal device, and the PCell in the MCG is configured with physical uplink control channel (PUCCH) resources. The SCells in the MCG are usually not configured with any PUCCH resource. The SCG refers to a cell group associated with the SN. The SCG includes one PSCell and optionally one or more SCells. The PSCell in the SCG is the only serving cell configured with the PUCCH resources in the SCG.

### 2. Conditional Handover (CHO)

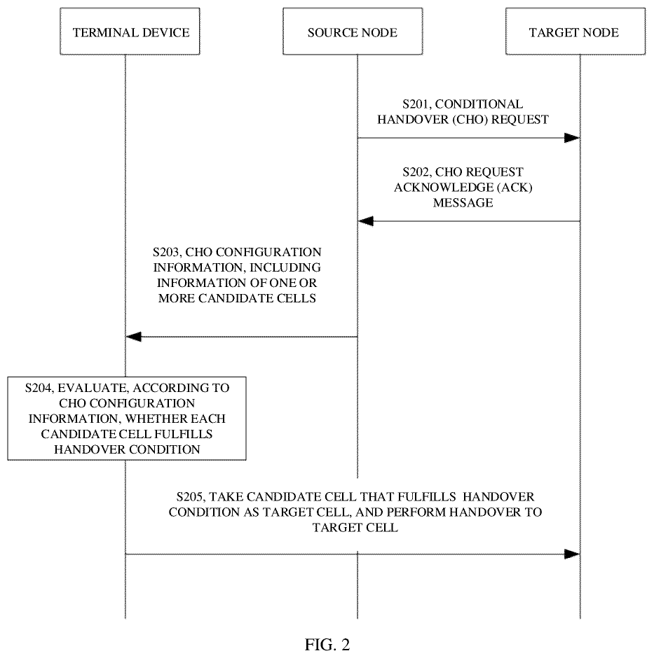

A CHO mechanism is a mechanism to enhance robustness of handover or SN addition, which can improve the success rate of handover performed by the terminal device. Specifically, FIG. 2 illustrates a schematic flowchart of CHO performed by the terminal device, and operations at S201 to S205 are included.

S201, a source node sends a CHO request to a candidate target node.

S202, the candidate target node allocates necessary radio resources for the terminal device and then sends a CHO request acknowledge (ACK) message to the source node.

S203, the source node sends CHO configuration information to the terminal device, where the CHO configuration information includes information of one or more candidate cells configured by a network device for the terminal device and a handover condition(s) (or referred to as “handover execution condition”) corresponding to each candidate cell.

S204, after the CHO configuration information is received by the terminal device, the terminal device evaluates, according to the CHO configuration information, whether each candidate cell fulfills the handover condition.

S205, the terminal device takes a candidate cell that fulfills the handover condition as a target cell and performs handover to the target cell.

In a CHO procedure as illustrated in FIG. 2, when a source link has a good quality, the source node can send the CHO configuration information to the terminal device, thereby ensuring the success rate of sending the CHO configuration information. Then, the terminal device spontaneously selects the target cell according to the CHO configuration information and performs handover to the target cell, which also improves the success rate of the handover.

### 3. Conditional PSCell Change (CPC)

A CPC mechanism can be understood as a CHO mechanism on an SN side. The CPC mechanism is a procedure in which an MN or an SN sends configuration information of candidate PSCells and change conditions for candidate PSCells change to the terminal device in advance, so that the terminal device can spontaneously perform PSCell change when the terminal device determines that a candidate PSCell fulfills a change condition for a PSCell change. In general, “PSCell change” is also referred to as “PSCell switch”.

In general, in the case where parameters of the multiple candidate SCGs are configured through delta signaling mechanism, after the terminal device performs PSCell change to a target SCG, other SCGs (i.e., SCGs other than the target SCG in the multiple candidate SCGs) will be released. When the terminal device performs SN switch next time, the terminal device can reobtain multiple candidate SCGs for target SCG evaluation, thereby completing SN switch. However, there can be overlapping candidate SCGs among the multiple candidate SCGs obtained when the terminal device performs SN switch each time. As can be seen, if the terminal device needs to reobtain candidate SCGs from the network side when performing SN switch each time, certain communication transmission resources will be wasted.

In order to save communication transmission resources, methods and apparatuses for SCG configuration, a chip, and a module device are provided in the present disclosure. The methods and the apparatuses for SCG configuration, the chip, and the module device provided in implementations of the present disclosure will be described in detail below.

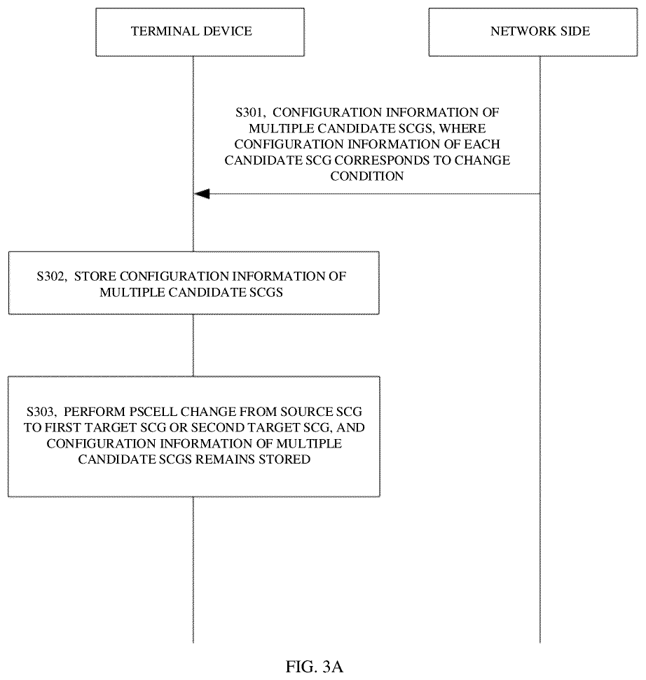

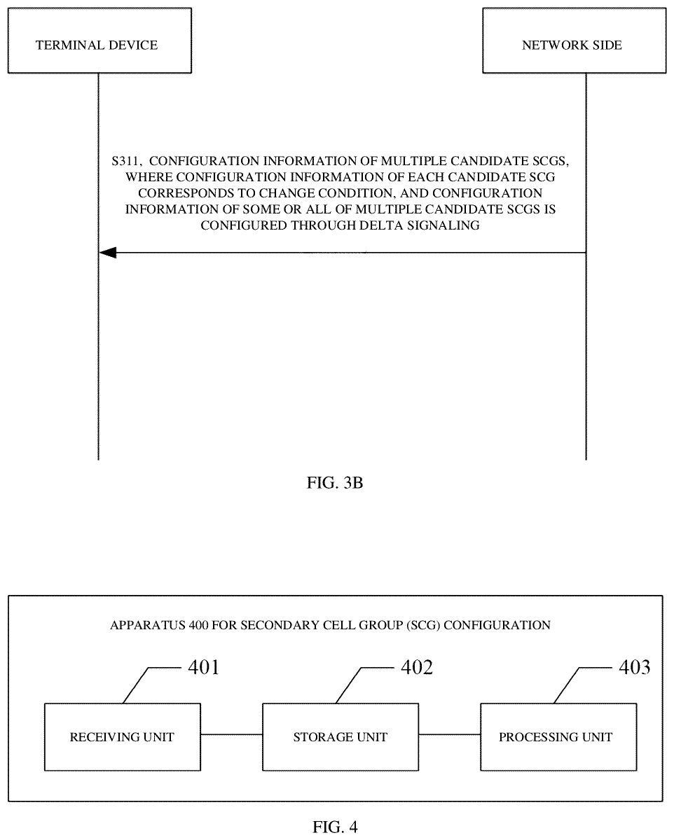

Reference can be made to FIG. 3A, which is a schematic flowchart of a method for SCG configuration provided in implementations of the present disclosure. As illustrated in FIG. 3A, the method for SCG configuration includes operations at S301 to S303 as follows. The method as illustrated in FIG. 3A can be implemented by a terminal device or a chip in the terminal device. For illustrative purposes, the method as illustrated in FIG. 3A is implemented by the terminal device.

S301, the terminal device receives configuration information of multiple candidate SCGs from a network side, where configuration information of each candidate SCG corresponds to a change condition (i.e. PSCell change condition).

The network side sends the configuration information of the multiple candidate SCGs to the terminal device, where each candidate SCG (or referred to as the configuration information of each candidate SCG) corresponds to a change condition. The change condition corresponding to each candidate SCG is a change condition for a PSCell in the candidate SCG. It can be appreciated that the change condition for each candidate SCG can be the same or different, which is not specifically limited in the present disclosure. Herein, the network side can be an MN accessed by the terminal device or an SN accessed by the terminal device, which is not specifically limited in the present disclosure.

In a possible implementation, a manner in which the terminal device receives the configuration information of the multiple candidate SCGs from the MN can include the following. The MN receives configuration information of multiple candidate SCGs from at least one candidate SN via a transparent container. Further, the MN sends the configuration information of the multiple candidate SCGs to the terminal device.

In a possible implementation, the configuration information of the multiple candidate SCGs is configured through delta signaling or full configuration. The delta signaling can simply include the following. Configuration parameters of a source SCG are taken as references, and configuration parameters of each candidate SCG different from the configuration parameters of the source SCG are configured through delta signaling.

In other words, when the configuration information of the candidate SCG is configured through delta signaling, the configuration information of the candidate SCG includes necessary configuration parameters of the candidate SCG. In this case, all (complete or entire) configuration parameters of the candidate SCG can be obtained only according to the configuration information of the candidate SCG and the reference (i.e., the configuration parameters of the source SCG). When the configuration information of the candidate SCG is configured through full configuration, the configuration information of the candidate SCG includes all the configuration parameters of the candidate SCG.

Exemplarily, the configuration parameters of the source SCG are: a11, b12, c13, and d14, and the configuration parameters of the candidate SCG are: a11, b12, c33, and d34. In this case, if the configuration information of the candidate SCG is configured through delta signaling, the configuration information of the candidate SCG indicates that c13 in the configuration parameters of the source SCG can be replaced with c33 and d14 in the configuration parameters of the source SCG can be replaced with d34. In other words, the configuration information of the candidate SCG only needs to indicate c33 and d34. If the configuration information of the candidate SCG is configured through full configuration, the configuration information of the candidate SCG indicates that the configuration parameters of the candidate SCG are a11, b12, c33, and d34. It is important to know that the delta signaling also abides by some rules. For example, some of the configuration parameters are allowed to be configured through delta signaling, while some of the configuration parameters are not allowed to be configured through delta signaling.

S302, the terminal device stores the configuration information of the multiple candidate SCGs.

After the configuration information of the multiple candidate SCGs is received by the terminal device, the terminal device stores the configuration information of the multiple candidate SCGs. The following will describe, based on how the configuration information of the multiple candidate SCGs is configured, manners in which the terminal device stores the configuration information of the multiple candidate SCGs in the following two cases.

Case 1: the configuration information of the multiple candidate SCG is configured through full configuration.

In this case, since the terminal device can determine all the configuration parameters of the candidate SCGs according to the configuration information of the candidate SCGs, the terminal device directly stores the configuration information of the multiple candidate SCGs. Exemplarily, configuration information of each candidate SCG is configured through full configuration, and the terminal device receives configuration information of four candidate SCGs, where configuration information of candidate SCG1 is a11, b12, c13, and d14; configuration information of candidate SCG2 is a21, b22, c23, and d24; configuration information of candidate SCG3 is a31, b32, c33, and d34; and configuration information of candidate SCG4 is a41, b42, c43, and d44. In this case, the terminal device stores the configuration information of the four candidate SCGs as illustrated in Table 1.

TABLE 1

| identity (ID) of | configuration information of |
|---|---|
| candidate SCG | candidate SCG |
| candidate SCG1 | a11, b12, c13, d14 |
| candidate SCG2 | a21, b22, c23, d24 |
| candidate SCG3 | a31, b32, c33, d34 |
| candidate SCG4 | a41, b42, c43, d44 |

Case 2: the configuration information of the multiple candidate SCG is configured through delta signaling.

In this case, the terminal device receives a first indication message from the network side, where the first indication message indicates configuration parameters of a source SCG at a first moment as reference configuration parameters, and the first moment is a moment at which the first indication message is received. Further, the terminal device stores the reference configuration parameters and the configuration information of the multiple candidate SCGs in an associative manner.

In other words, the first indication message can indicate that the terminal device stores configuration parameters of a source SCG at a current moment, and further, the terminal device stores the configuration parameters of the source SCG at the current moment as reference configuration parameters. It is noted that the network side can change the configuration parameters of the source SCG while sending the first indication message. In other words, the network side can carry both the SCG configuration parameters (for changing the configuration parameters of the source SCG) and the first indication message in one signaling. In this case, if the configuration information of the multiple candidate SCGs is set according to changed configuration parameters of the source SCG (i.e., the SCG configuration parameters in the signaling), the terminal device stores the changed configuration parameters of the source SCG (i.e., the SCG configuration parameters in the signaling) according to the first indication message. If the configuration information of the multiple candidate SCGs is set according to to-be-changed configuration parameters of the source SCG (i.e., SCG configuration parameters before the signaling is received by the terminal device), the terminal device stores the to-be-changed configuration parameters of the source SCG according to the first indication message. In other words, as long as the network side and the terminal device adopt the same mechanism (e.g., both adopt the changed SCG configuration parameters as the reference configuration parameters), stored parameters (i.e., the reference configuration parameters) will not be mismatched.

It can be understood that since the configuration information of the candidate SCG is configured through delta signaling, the terminal device is unable to determine all the configuration parameters of the candidate SCG only according to the configuration information of the candidate SCG, and the terminal device also needs to know the reference configuration parameters corresponding to the configuration information of the multiple candidate SCGs to determine all the configuration parameters of the candidate SCG. Therefore, when the network side sends configuration information of at least one candidate SCG to the terminal device, the network side indicates reference configuration parameters corresponding to the configuration information of the at least one candidate SCG (i.e., the configuration parameters of the source SCG at the first moment) to the terminal device.

Exemplarily, the terminal device receives the first indication message and configuration information of two candidate SCGs from the network side, where configuration information of candidate SCG5 is c53 and d54, and configuration information of candidate SCG6 is a61 and d64. The first indication message indicates that the configuration information of candidate SCG5 and the configuration information of candidate SCG6 are based on the configuration parameters of the source SCG at the first moment as reference configuration parameters, and the configuration parameters of the source SCG at the first moment is a00, b00, c00, and d00. In this case, the terminal device stores the configuration parameters of the source SCG at the first moment and the configuration information of the two candidate SCGs (i.e., candidate SCG5 and candidate SCG6) in an associative manner as illustrated in Table 2.

TABLE 2

| | | reference |
|---|---|---|
| | configuration information | configuration |
| ID of candidate SCG | of candidate SCG | parameters |
| candidate SCG5 | c53, d54 | a00, b00, c00, d00 |
| candidate SCG6 | a61, d64 | |

It can be understood that the terminal device can determine, according to the configuration information of the candidate SCGs and the reference configuration parameters, that the configuration parameters of candidate SCG 5 are a00, b00, c53, and d54, and the configuration parameters of candidate SCG 6 are a61, b00, c00, and d64.

In a possible implementation, the network side (can be the MN accessed by the terminal device or the SN accessed by the terminal device) receives a handover request ACK signaling from a candidate SN(s), and determines (or understood as “obtains”), according to the handover request ACK signaling, that the configuration information of the multiple candidate SCGs is configured through delta signaling. In this case, the network side sends the first indication message to the terminal device. It can be understood that the handover request ACK signaling can explicitly indicate that the configuration information of the candidate SCGs is configured through delta signaling or full configuration. Alternatively, the configuration information of the candidate SCGs is configured through delta signaling by default when the handover request ACK signaling does not explicitly indicate the configuration information of the candidate SCGs. As a result, a source network side (i.e., the MN accessed by the terminal device accesses or the SN accessed by the terminal device accesses) can accordingly determine whether the configuration information of the candidate SCGs is configured through delta signaling.

In a possible implementation, one or more sets of reference configuration parameters can be stored in a storage space of the terminal device, and each set of reference configuration parameters is associated with configuration information of at least one of the multiple candidate SCGs. Exemplarily, as illustrated in Table 3, configuration information of five candidate SCGs is stored in the storage space of the terminal device.

TABLE 3

| | configuration | reference |
|---|---|---|
| ID of | information of | configuration |
| candidate SCG | candidate SCG | parameters |
| candidate SCG5 | c53, d54 | a00, b00, c00, d00 |
| candidate SCG6 | a61, d64 | |
| candidate SCG7 | a71, b72 | a01, b01, c01, d01 |
| candidate SCG8 | b82, c83 | |
| candidate SCG9 | a91, c93, d94 | |

S303, the terminal device performs PSCell change from the source SCG to a first target SCG or a second target SCG.

Specifically, in a possible implementation, in the case where the terminal device determines that the first target SCG fulfills a change condition, the terminal device performs PSCell change from the source SCG to the first target SCG, where the first target SCG is one of the multiple candidate SCGs. In other words, each of the multiple candidate SCGs corresponds to a change condition (which can be understood as a change condition for a candidate PSCell in the candidate SCG). In this implementation, the terminal device evaluates whether the candidate PSCell fulfills the change condition. If a candidate PSCell corresponding to the first target SCG fulfills the change condition, the terminal device performs PSCell change from the source SCG to the first target SCG. Additionally, after the terminal device performs PSCell change from the source SCG to the first target SCG, the configuration information of the multiple candidate SCGs stored in the terminal device at S302 remains stored (or understood as “not released”) in the terminal device. It can be noted that after the terminal device performs PSCell change to the first target SCG such as SCG5 in Table 3, configuration information of other four SCGs, i.e., SCG6, SCG7, SCG8, and SCG9, remains stored (or understood as “not released”) in the terminal device. Since the terminal device has accessed SCG5, SCG5 will not be taken as a candidate SCG and configuration of SCG5 will not remain stored on the terminal device side.

Alternatively, in another possible implementation, the terminal device performs PSCell change from the source SCG to the second target SCG, where the second target SCG is designated by the network side, and the second target SCG is one of the multiple candidate SCGs or is not included in the multiple candidate SCGs. In other words, in this possible implementation, the terminal device receives an indication message from the network side, and the indication message indicates that the terminal device performs PSCell change from the source SCG to an SCG (i.e., the second target SCG), where the second target SCG can be one of the multiple candidate SCGs at S301 or may not be included in the multiple candidate SCGs. The indication message includes ID information of the second target SCG and configuration information of the second target SCG. Further, the terminal device performs PSCell change from the source SCG to the second target SCG.

After the terminal device performs PSCell change from the source SCG to the first target SCG or the second target SCG, the configuration information of the multiple candidate SCGs remains stored in the terminal device (or means that the configuration information of the multiple candidate SCGs stored in the terminal device is not released). After the terminal device stores the configuration information of the multiple candidate SCGs, if the terminal device performs PSCell change, the configuration information of the multiple candidate SCGs remains stored in the terminal device by default. In another possible implementation, the terminal device receives a third indication message from the network side, where the third indication message indicates that the configuration information of the multiple candidate SCGs remained stored in the terminal device after a PSCell is changed (i.e., after the terminal device stores the configuration information of the multiple candidate SCGs, the terminal device performs PSCell change). In other words, in this implementation, the configuration information of the multiple candidate SCGs remained stored in the terminal device according to the indication from the network side.

Based on the method for SCG configuration provided in FIG. 3A, the configuration information of the multiple candidate SCGs stored in the terminal device is not released, and the terminal device can subsequently continue to evaluate the candidate SCGs to determine whether the PSCell in each candidate SCG fulfills the change condition. In this way, the terminal device can directly utilize the configuration information of the candidate SCGs obtained from the storage space in a subsequent SCG change, thereby saving signaling overhead for reconfiguration of the candidate SCGs by the network.

In this implementation, the configuration information of the multiple candidate SCGs is received from the network side at S301, where “multiple” can be one or more. When there is configuration information of only one candidate SCG, if the terminal device performs conditional PSCell change and accesses a PSCell corresponding to the candidate SCG, i.e., the candidate SCG is the first target SCG of the terminal device, and there is no configuration information of another candidate SCG other than the configuration information of the first target SCG on the terminal device side, the configuration information of the multiple candidate SCGs is not required to remain stored in the terminal device. When there is the configuration information of only one candidate SCG, if the terminal device accesses the second target SCG according to the indication from the network side, the second target SCG is the candidate SCG, and there is no configuration information of another candidate SCG other than the configuration information of the second target SCG on the terminal device side after the terminal device has accessed the second target SCG, the configuration information of the multiple candidate SCGs is also not required to remain stored in the terminal device.

Since the terminal device has a limited storage space, the terminal device can also release the configuration information of the candidate SCGs according to a demand of the terminal device or the indication from the network side, so as to save the storage space of the terminal device.

In a possible implementation, in the case where the terminal device performs PCell handover, the terminal device releases the configuration information of the multiple candidate SCGs.

Exemplarily, when the terminal device is in a PCell A, the terminal device receives configuration information of candidate SCG1, candidate SCG2, and candidate SCG3. When the terminal device does not perform PCell handover, the configuration information of candidate SCG1, candidate SCG2, and candidate SCG3 remains stored in the terminal device. When the terminal device performs PCell handover from the PCell A to a target PCell B, the terminal device releases the configuration information of the candidate SCGs received in the PCell A, i.e., the terminal device releases the configuration information of candidate SCG1, candidate SCG2, and candidate SCG3.

In a possible implementation, after the terminal device performs RRC re-establishment, the terminal device releases the configuration information of the multiple candidate SCGs.

Exemplarily, the terminal device receives the configuration information of candidate SCG1, candidate SCG2, and candidate SCG3. After the terminal device performs RRC re-establishment (or when the terminal device notices that the terminal device needs to perform RRC re-establishment, or when the terminal device is performing RRC re-establishment), the terminal device releases the configuration information of the multiple candidate SCGs received before RRC re-establishment is performed, i.e., the terminal device releases the configuration information of candidate SCG1, candidate SCG2, and candidate SCG3.

In a possible implementation, the terminal device receives a second indication message from the network side, where the second indication message indicates release of configuration information of some or all of the multiple candidate SCGs. Further, the terminal device releases the configuration information of some or all of the multiple candidate SCGs.

In other words, the network side sends the second indication message to the terminal device, and the second indication message includes ID information of the candidate SCGs to-be-released. The candidate SCGs to-be-released can be the configuration information of some of the candidate SCGs in the storage space of the terminal device. Alternatively, the candidate SCGs to-be-released can be the configuration information of all of the candidate SCGs in the storage space of the terminal device.

In a possible implementation, in the case where configuration information of candidate SCGs associated with a first set of reference configuration parameters in the storage space has all been released, the first set of reference configuration parameters is released, where the first set of reference configuration parameters is one of the one or more sets of reference configuration parameters. In other words, one or more sets of reference configuration parameters are stored in the storage space of the terminal device, and each set of reference configuration parameters is associated with configuration information of at least one candidate SCG. When configuration information of candidate SCGs associated with a set of reference configuration parameters has all been released, the terminal device releases the set of reference configuration parameters. Similarly, if the terminal device releases the first set of reference configuration parameters, the terminal device needs to release the configuration information of the candidate SCGs associated with the first set of reference configuration parameters.

Exemplarily, the configuration information of the multiple candidate SCGs in the storage space is illustrated in Table 3. In the case where the terminal device releases the configuration information of candidate SCG5, the configuration information of candidate SCG6, and the configuration information of candidate SCG7, the terminal device releases the reference configuration parameters associated with the configuration information of candidate SCG5 and the configuration information of candidate SCG6, but remains the reference configuration parameters associated with the configuration information of candidate SCG7.

Reference can be made to FIG. 3B, which is a schematic flowchart of a method for SCG configuration provided in implementations of the present disclosure. As illustrated in FIG. 3B, the method for SCG configuration includes operations at S311 as follows. The method as illustrated in FIG. 3B can be implemented by a terminal device or a chip in the terminal device. For illustrative purposes, the method as illustrated in FIG. 3B is implemented by the terminal device.

S311, the terminal device receives configuration information of multiple candidate SCGs from a network side, where configuration information of each candidate SCG corresponds to a change condition. Configuration information of some or all of the multiple candidate SCGs is configured through delta signaling, configuration information of candidate SCGs configured through delta signaling is based on at least one set of reference configuration parameters, and the at least one set of reference configuration parameters is configured by the network side.

In other words, the network side sends the configuration information of the multiple candidate SCGs to the terminal device, where each candidate SCG (or referred to as the configuration information of each candidate SCG) corresponds to the change condition. Configuration information of at least one of the multiple candidate SCGs is configured through delta signaling, and the configuration information of the at least one candidate SCG is based on the same set of reference configuration parameters or multiple sets of reference configuration parameters.

It can be noted that for descriptions of change conditions corresponding to the candidate SCGs, reference can be made to descriptions of the change conditions corresponding to the candidate SCGs at S301. For descriptions of the delta signaling, reference can be made to related descriptions of the delta signaling in FIG. 3A. For specific implementations in which the configuration information of the at least one candidate SCG (i.e., configuration information of the candidate SCGs configured through delta signaling) is based on the at least one set of reference configuration parameters, reference can be made to manners of Table 2 or Table 3, which is not repeated herein.

In a possible implementation, the at least one set of reference configuration parameters is configured by the network side as follows. The terminal device receives a first indication message from the network side, where the first indication message indicates configuration parameters of a source SCG at a first moment as reference configuration parameters, and the first moment is a moment at which the first indication message is received. For the possible implementation, reference can be made to related descriptions of Case 2 at S302.

In a possible implementation, the terminal device stores the configuration information of the multiple candidate SCGs. For the possible implementation, reference can be made to related descriptions at S302.

In a possible implementation, in the case where the terminal device determines that the first target SCG fulfills a change condition, the terminal device performs PSCell change from the source SCG to a first target SCG, where the first target SCG is one of the multiple candidate SCGs. Alternatively, the terminal device performs PSCell change from the source SCG to a second target SCG, where the second target SCG is designated by the network side, and the second target SCG is one of the multiple candidate SCGs or is not included in the multiple candidate SCGs. After the terminal device performs PSCell change from the source SCG to the first target SCG or the second target SCG, the configuration information of the multiple candidate SCGs remains stored in the terminal device. For the possible implementation, reference can be made to related descriptions at S302.

Reference can be made to FIG. 4, which is a schematic structural diagram of an apparatus for SCG configuration provided in implementations of the present disclosure. The apparatus can be an SN or an apparatus with the functions of the SN (e.g., a chip). Specifically, as illustrated in FIG. 4, the apparatus 400 for SCG configuration can include a receiving unit 401, a storage unit 402, and a processing unit 403. The receiving unit 401 is configured to receive configuration information of multiple candidate SCGs from a network side, where each of the multiple candidate SCGs corresponds to a change condition. The storage unit 402 is configured to store the configuration information of the multiple candidate SCGs. The processing unit 403 is configured to perform PSCell change from a source SCG to a first target SCG in response to the terminal device determining that the first target SCG fulfills a change condition, where the first target SCG is one of the multiple candidate SCGs. Alternatively, the processing unit 403 is configured to perform PSCell change from the source SCG to a second target SCG, where the second target SCG is designated by the network side, and the second target SCG is one of the multiple candidate SCGs or is not included in the multiple candidate SCGs. After the terminal device performs PSCell change from the source SCG to the first target SCG or the second target SCG, the configuration information of the multiple candidate SCGs remains stored in the terminal device.

In a possible implementation, the configuration information of the multiple candidate SCGs is configured through delta signaling or full configuration.

In a possible implementation, the configuration information of the multiple candidate SCGs is configured through delta signaling. The receiving unit 401 is further configured to receive a first indication message from the network side, where the first indication message indicates configuration parameters of a source SCG at a first moment as reference configuration parameters, and the first moment is a moment at which the first indication message is received. The storage unit 402 is further configured to store the reference configuration parameters and the configuration information of the multiple candidate SCGs in an associative manner.

In a possible implementation, in the case where the network side determines, according to a handover request ACK signaling from a candidate SN, that the configuration information of the multiple candidate SCGs is configured through delta signaling, the receiving unit 401 is further configured to receive the first indication message from the network side.

In a possible implementation, in the case where the terminal device performs PCell handover, the storage unit 402 is further configured to release the configuration information of the multiple candidate SCGs.

In a possible implementation, after the terminal device performs RRC re-establishment, the storage unit 402 is further configured to release the configuration information of the multiple candidate SCGs.

In a possible implementation, the receiving unit 401 is further configured to receive a second indication message from the network side, where the second indication message indicates release of configuration information of some or all of the multiple candidate SCGs. The storage unit 402 is further configured to release the configuration information of some or all of the multiple candidate SCGs.

In a possible implementation, one or more sets of reference configuration parameters are stored in a storage space of the terminal device, and each set of reference configuration parameters is associated with configuration information of at least one of the multiple candidate SCGs.

In a possible implementation, in the case where configuration information of candidate SCGs associated with a first set of reference configuration parameters in the storage space has all been released, the storage unit 402 is further configured to release the first set of reference configuration parameters, where the first set of reference configuration parameters is one of the one or more sets of reference configuration parameters.

In a possible implementation, the receiving unit 401 is further configured to receive a third indication message from the network side, where the third indication message indicates that the configuration information of the multiple candidate SCGs remains stored in the terminal device after a PSCell is changed.

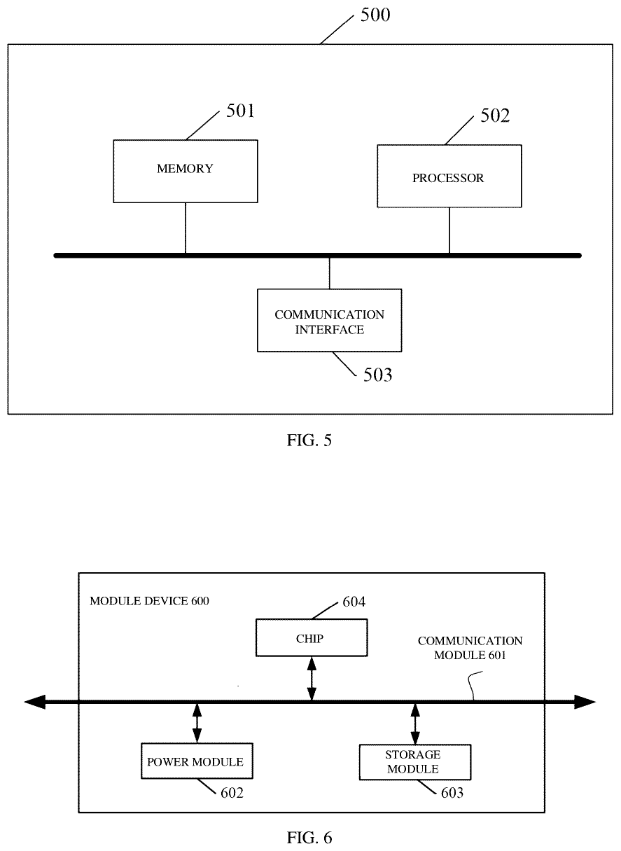

Reference can be made to FIG. 5, which is a schematic structural diagram of a terminal device provided in implementations of the present disclosure. The terminal device 500 can include a memory 501 and a processor 502. Optionally, the terminal device 500 further includes a communication interface 503. The memory 501, the processor 502, and the communication interface 503 are connected to each other via one or more communication buses. The communication interface 503 is controlled by the processor 502 for transmitting and receiving information. The memory 501 can include a read-only memory (ROM) and a random access memory (RAM) and provide instructions and data to the processor 502. A portion of the memory 501 can also include non-volatile RAM. The communication interface 503 is configured to receive or transmit data. The processor 502 can be a central processing unit (CPU), other general-purpose processors, a digital signal processor (DSP), an application-specific integrated circuit (ASIC), field-programmable gate array (FPGA), other programmable logic devices, discrete gates or transistor logic devices, discrete hardware components, etc. The general-purpose processor can be a microprocessor, and optionally, the processor 502 can be any conventional processor or the like.

The memory 501 is configured to store program instructions.

The processor 502 is configured to invoke the program instructions stored in memory 501.

The processor 502 is configured to invoke the program instructions stored in the memory 501 to cause the terminal device 500 to operate as follows. Configuration information of multiple candidate SCGs is received from a network side, where each of the multiple candidate SCGs corresponds to a change condition. The configuration information of the multiple candidate SCGs is stored. In the case where the terminal device determines that the first target SCG fulfills a change condition, PSCell change is performed from a source SCG to a first target SCG, where the first target SCG is one of the multiple candidate SCGs. Alternatively, PSCell change is performed from the source SCG to a second target SCG, where the second target SCG is designated by the network side, and the second target SCG is one of the multiple candidate SCGs or is not included in the multiple candidate SCGs. After the terminal device performs PSCell change from the source SCG to the first target SCG or the second target SCG, the configuration information of the multiple candidate SCGs remains stored in the terminal device.

In a possible implementation, the configuration information of the multiple candidate SCGs is configured through delta signaling or full configuration.

In a possible implementation, the configuration information of the multiple candidate SCGs is configured through delta signaling. The processor 502 is further configured to receive a first indication message from the network side, where the first indication message indicates configuration parameters of a source SCG at a first moment as reference configuration parameters, and the first moment is a moment at which the first indication message is received. The processor 502 is further configured to store the reference configuration parameters and the configuration information of the multiple candidate SCGs in an associative manner.

In a possible implementation, in the case where the network side determines, according to a handover request ACK signaling from a candidate SN, that the configuration information of the multiple candidate SCGs is configured through delta signaling, the processor 502 is further configured to receive the first indication message from the network side.

In a possible implementation, in the case where the terminal device performs PCell handover, the configuration information of the multiple candidate SCGs is released.

In a possible implementation, after the terminal device performs RRC re-establishment, the configuration information of the multiple candidate SCGs is released.

In a possible implementation, the processor 502 is further configured to receive a second indication message from the network side, where the second indication message indicates release of configuration information of some or all of the multiple candidate SCGs. The processor 502 is further configured to release the configuration information of some or all of the multiple candidate SCGs.

In a possible implementation, one or more sets of reference configuration parameters are stored in a storage space of the terminal device, and each set of reference configuration parameters is associated with configuration information of at least one of the multiple candidate SCGs.

In a possible implementation, in the case where configuration information of candidate SCGs associated with a first set of reference configuration parameters in the storage space has all been released, the first set of reference configuration parameters is released, where the first set of reference configuration parameters is one of the one or more sets of reference configuration parameters.

In a possible implementation, the processor 502 is further configured to receive a third indication message from the network side, where the third indication message indicates that the configuration information of the multiple candidate SCGs remains stored in the terminal device after a PSCell is changed.

It can be noted that for contents not mentioned and specific implementations of various operations in implementations corresponding to FIG. 4 or FIG. 5, reference can be made to implementations illustrated in FIG. 3A or FIG. 3B as well as the foregoing, which is not repeated herein.

A chip is further provided in implementations of the present disclosure. The chip is configured to perform operations related to the terminal device in the method implementations. The chip includes a processor and a communication interface. The processor is configured to invoke the communication interface to operate as follows. Configuration information of multiple candidate SCGs is received from a network side, where each of the multiple candidate SCGs corresponds to a change condition. The configuration information of the multiple candidate SCGs is stored. In the case where the terminal device determines that the first target SCG fulfills a change condition, PSCell change is performed from a source SCG to a first target SCG, where the first target SCG is one of the multiple candidate SCGs. Alternatively, PSCell change is performed from the source SCG to a second target SCG, where the second target SCG is designated by the network side, and the second target SCG is one of the multiple candidate SCGs or is not included in the multiple candidate SCGs. After the terminal device performs PSCell change from the source SCG to the first target SCG or the second target SCG, the configuration information of the multiple candidate SCGs remains stored in the terminal device.

In a possible implementation, the configuration information of the multiple candidate SCGs is configured through delta signaling or full configuration.

In a possible implementation, the configuration information of the multiple candidate SCGs is configured through delta signaling. The processor is further configured to receive a first indication message from the network side, where the first indication message indicates configuration parameters of a source SCG at a first moment as reference configuration parameters, and the first moment is a moment at which the first indication message is received. The processor is further configured to store the reference configuration parameters and the configuration information of the multiple candidate SCGs in an associative manner.

In a possible implementation, in the case where the network side determines, according to a handover request ACK signaling from a candidate SN, that the configuration information of the multiple candidate SCGs is configured through delta signaling, the processor is further configured to receive the first indication message from the network side.

In a possible implementation, in the case where the terminal device performs PCell handover, the configuration information of the multiple candidate SCGs is released.

In a possible implementation, after the terminal device performs RRC re-establishment, the configuration information of the multiple candidate SCGs is released.

In a possible implementation, the processor is further configured to receive a second indication message from the network side, where the second indication message indicates release of configuration information of some or all of the multiple candidate SCGs. The processor is further configured to release the configuration information of some or all of the multiple candidate SCGs.

In a possible implementation, one or more sets of reference configuration parameters are stored in a storage space of the terminal device, and each set of reference configuration parameters is associated with configuration information of at least one of the multiple candidate SCGs.

In a possible implementation, in the case where configuration information of candidate SCGs associated with a first set of reference configuration parameters in the storage space has all been released, the first set of reference configuration parameters is released, where the first set of reference configuration parameters is one of the one or more sets of reference configuration parameters.

In a possible implementation, the processor is further configured to receive a third indication message from the network side, where the third indication message indicates that the configuration information of the multiple candidate SCGs remains stored in the terminal device after a PSCell is changed.

As illustrated in FIG. 6, FIG. 6 is a schematic structural diagram of a module device provided in implementations of the present disclosure. The module device 600 can perform operations related to the terminal device in the method implementations. The module device 600 includes a communication module 601, a power module 602, a storage module 603, and a chip 604. The power module 602 is configured to power the module device. The storage module 603 is configured to store data and instructions. The communication module 601 is configured to perform internal communication within the module device or perform communication between the module device and an external device. The chip 604 is configured to receive configuration information of multiple candidate SCGs from a network side, where each of the multiple candidate SCGs corresponds to a change condition. The chip 604 is configured to store the configuration information of the multiple candidate SCGs. The chip 604 is configured to perform PSCell change from a source SCG to a first target SCG in response to the terminal device determining that the first target SCG fulfills a change condition, where the first target SCG is one of the multiple candidate SCGs. Alternatively, the chip 604 is configured to perform PSCell change from the source SCG to a second target SCG, where the second target SCG is designated by the network side, and the second target SCG is one of the multiple candidate SCGs or is not included in the multiple candidate SCGs. After the terminal device performs PSCell change from the source SCG to the first target SCG or the second target SCG, the configuration information of the multiple candidate SCGs remains stored in the terminal device.

In a possible implementation, the configuration information of the multiple candidate SCGs is configured through delta signaling or full configuration.

In a possible implementation, the configuration information of the multiple candidate SCGs is configured through delta signaling. The chip 604 is further configured to receive a first indication message from the network side, where the first indication message indicates configuration parameters of a source SCG at a first moment as reference configuration parameters, and the first moment is a moment at which the first indication message is received. The chip 604 is further configured to store the reference configuration parameters and the configuration information of the multiple candidate SCGs in an associative manner.

In a possible implementation, in the case where the network side determines, according to a handover request ACK signaling from a candidate SN, that the configuration information of the multiple candidate SCGs is configured through delta signaling, the chip 604 is further configured to receive the first indication message from the network side.

In a possible implementation, in the case where the terminal device performs PCell handover, the configuration information of the multiple candidate SCGs is released.

In a possible implementation, after the terminal device performs RRC re-establishment, the configuration information of the multiple candidate SCGs is released.

In a possible implementation, the chip 604 is further configured to receive a second indication message from the network side, where the second indication message indicates release of configuration information of some or all of the multiple candidate SCGs. The chip 604 is further configured to release the configuration information of some or all of the multiple candidate SCGs.

In a possible implementation, one or more sets of reference configuration parameters are stored in a storage space of the terminal device, and each set of reference configuration parameters is associated with configuration information of at least one of the multiple candidate SCGs.

In a possible implementation, in the case where configuration information of candidate SCGs associated with a first set of reference configuration parameters in the storage space has all been released, the first set of reference configuration parameters is released, where the first set of reference configuration parameters is one of the one or more sets of reference configuration parameters.

In a possible implementation, the chip 604 is further configured to receive a third indication message from the network side, where the third indication message indicates that the configuration information of the multiple candidate SCGs remains stored in the terminal device after a PSCell is changed.

A computer-readable storage medium is further provided in implementations of the present disclosure. The computer-readable storage medium is configured to store instructions which, when executed on a processor, cause the processor to implement the operations of the method in the method implementations.

A computer program product is further provided in implementations of the present disclosure. When the computer program product is executed on a processor, the processor can implement the operations of the method in the method implementations.

For each apparatus and product described in the implementations, each module/unit included can be a software module/unit, a hardware module/unit, or can be partially a software module/unit and partially a hardware module/unit. For example, for each apparatus and product applied to or integrated into the chip, each module/unit included can be implemented by hardware such as circuits, or at least part of modules/units can be implemented by software programs that run on a processor integrated into the chip, and the rest (if any) of modules/units can be implemented by hardware such as circuits. For each apparatus and product applied to or integrated into the chip module, each module/unit included can be implemented by hardware such as a circuit, and different modules/units can be located in a same component (such as a chip, a circuit module, etc.) or different components of the chip module. Alternatively, at least part of modules/units can be implemented by software programs that run on the processor integrated into the chip module, and the rest (if any) of modules/units can be implemented by hardware such as circuits. For each apparatus and product applied to or integrated into the terminal, each module/unit included can be implemented by hardware such as circuits, and different modules/units can be located in a same component (e.g., a chip, a circuit module, etc.) or different components in the terminal, or at least part of modules/units can be implemented by software programs that run on the processor integrated into the terminal, and the rest (if any) of modules/units can be implemented by hardware such as circuits.

It can be noted that, for the sake of simplicity, the foregoing method implementations are described as a series of action combinations. However, it will be appreciated by those skilled in the art that implementations are not limited by the sequence of actions described. According to implementations, some steps or operations can be performed in other orders or simultaneously. Besides, it will be appreciated by those skilled in the art that the implementations described in the specification are exemplary implementations, and the actions and modules involved are not necessarily essential to the present disclosure.

Mutual reference can be made to the descriptions of various implementations of the present disclosure, and the description of each implementation has its own emphasis. For the parts not described in detail in one implementation, reference can be made to related descriptions in other implementations. For the sake of convenience and simplicity, for functions of the apparatuses and devices provided in implementations of the present disclosure and operations performed by the apparatuses and devices, reference can be made to related descriptions of the method implementations of the present disclosure. The method implementations and the apparatus implementations can also be mutually referred to, combined, or cited.

Finally, it can be noted that the foregoing implementations are merely intended for describing the technical solutions of the present disclosure, but not for limiting the present disclosure. Although the present disclosure is described in detail with reference to the foregoing implementations, those of ordinary skill in the art can understand that they can still make modifications to the technical solutions described in the foregoing implementations or make equivalent replacements to some or all technical features thereof, without departing from the scope of the technical solutions of implementations of the present disclosure.

1. A method for secondary cell group (SCG) configuration, applicable to a terminal device and comprising:
receiving configuration information of a plurality of candidate SCGs from a network side, wherein each of the plurality of candidate SCGs corresponds to a change condition;
storing the configuration information of the plurality of candidate SCGs; and
performing PSCell change from a source SCG to a first target SCG in response to the terminal device determining that the first target SCG fulfills a change condition, wherein the first target SCG is one of the plurality of candidate SCGs; or performing PSCell change from the source SCG to a second target SCG, wherein the second target SCG is designated by the network side, and the second target SCG is one of the plurality of candidate SCGs or is not comprised in the plurality of candidate SCGs; wherein
the configuration information of the plurality of candidate SCGs remains stored in the terminal device after the terminal device performs PSCell change from the source SCG to the first target SCG or the second target SCG.

2. The method of claim 1, wherein the configuration information of the plurality of candidate SCGs is configured through delta signaling or full configuration.

3. The method of claim 2, wherein
the configuration information of the plurality of candidate SCGs is configured through delta signaling, and the method further comprises:
receiving a first indication message from the network side, wherein the first indication message indicates configuration parameters of a source SCG at a first moment as reference configuration parameters, and the first moment is a moment at which the first indication message is received; and
storing the configuration information of the plurality of candidate SCGs comprises:
storing the reference configuration parameters and the configuration information of the plurality of candidate SCGs in an associative manner.

4. The method of claim 3, wherein the first indication message is sent from the network side in a case where the network side determines, according to a handover request acknowledge (ACK) signaling from a candidate secondary node (SN), that the configuration information of the plurality of candidate SCGs is configured through delta signaling.

5. The method of claim 1, further comprising:
releasing the configuration information of the plurality of candidate SCGs in a case where the terminal device performs primary cell (PCell) handover.

6. The method of claim 1, further comprising:
releasing the configuration information of the plurality of candidate SCGs after the terminal device performs radio resource control (RRC) re-establishment.

7. The method of claim 1, further comprising:
receiving a second indication message from the network side, wherein the second indication message indicates release of configuration information of some or all of the plurality of candidate SCGs; and
releasing the configuration information of some or all of the plurality of candidate SCGs.

8. The method of claim 1, wherein one or more sets of reference configuration parameters are stored in a storage space of the terminal device, and each set of reference configuration parameters is associated with configuration information of at least one of the plurality of candidate SCGs.

9. The method of claim 8, further comprising:
releasing a first set of reference configuration parameters in a case where configuration information of candidate SCGs associated with the first set of reference configuration parameters in the storage space has all been released, wherein the first set of reference configuration parameters is one of the one or more sets of reference configuration parameters.

10. The method of claim 1, further comprising:
receiving a third indication message from the network side, wherein the third indication message indicates that the configuration information of the plurality of candidate SCGs remained stored in the terminal device after primary secondary cell (PSCell) change is performed.

11. A method for secondary cell group (SCG) configuration, applicable to a terminal device and comprising:
receiving configuration information of a plurality of candidate SCGs from a network side, wherein each of the plurality of candidate SCGs corresponds to a change condition; wherein
configuration information of some or all of the plurality of candidate SCGs is configured through delta signaling, configuration information of candidate SCGs configured through delta signaling is based on at least one set of reference configuration parameters, and the at least one set of reference configuration parameters is configured by the network side.

12. The method of claim 11, further comprising:
receiving a first indication message from the network side, wherein the first indication message indicates configuration parameters of a source SCG at a first moment as reference configuration parameters, and the first moment is a moment at which the first indication message is received.

13. The method of claim 11, further comprising:
storing the configuration information of the plurality of candidate SCGs.

14. The method of claim 13, further comprising:
performing PSCell change from a source SCG to a first target SCG in response to the terminal device determining that the first target SCG fulfills a change condition, wherein the first target SCG is one of the plurality of candidate SCGs; or
performing PSCell change from the source SCG to a second target SCG, wherein the second target SCG is designated by the network side, and the second target SCG is one of the plurality of candidate SCGs or is not comprised in the plurality of candidate SCGs; wherein
the configuration information of the plurality of candidate SCGs remains stored in the terminal device after the terminal device performs PSCell change from the source SCG to the first target SCG or the second target SCG.

15-32. (canceled)

33. A terminal device, comprising:
a memory;
a processor; and
a communication interface:
wherein the terminal device is configured to:
receive configuration information of a plurality of candidate SCGs from a network side, wherein each of the plurality of candidate SCGs corresponds to a change condition;
store the configuration information of the plurality of candidate SCGs; and
perform PSCell change from a source SCG to a first target SCG in response to the terminal device determining that the first target SCG fulfills a change condition, wherein the first target SCG is one of the plurality of candidate SCGs; or performing PSCell change from the source SCG to a second target SCG, wherein the second target SCG is designated by the network side, and the second target SCG is one of the plurality of candidate SCGs or is not comprised in the plurality of candidate SCGs; wherein
the configuration information of the plurality of candidate SCGs remains stored in the terminal device after the terminal device performs PSCell change from the source SCG to the first target SCG or the second target SCG.

34. (canceled)

35. The terminal device of claim 33, wherein the configuration information of the plurality of candidate SCGs is configured through delta signaling or full configuration.

36. The terminal device of claim 35, wherein
the configuration information of the plurality of candidate SCGs is configured through delta signaling, and the terminal device is further configured to:
receive a first indication message from the network side, wherein the first indication message indicates configuration parameters of a source SCG at a first moment as reference configuration parameters, and the first moment is a moment at which the first indication message is received; and
in terms of storing the configuration information of the plurality of candidate SCGs, the terminal device is further configured to:
store the reference configuration parameters and the configuration information of the plurality of candidate SCGs in an associative manner.

37. The terminal device of claim 33, wherein the terminal device is further configured to:
release the configuration information of the plurality of candidate SCGs in a case where the terminal device performs primary cell (PCell) handover.

38. The terminal device of claim 33, wherein the terminal device is further configured to:
release the configuration information of the plurality of candidate SCGs after the terminal device performs radio resource control (RRC) re-establishment.

39. The terminal device of claim 33, wherein the terminal device is further configured to:
receive a second indication message from the network side, wherein the second indication message indicates release of configuration information of some or all of the plurality of candidate SCGs; and
release the configuration information of some or all of the plurality of candidate SCGs.
